(19) United States
(12) Patent Application Publication
(10) Pub. No.: US 2026/0311131 A1
(43) Pub. Date: Oct. 8, 2026

(54) IDENTIFICATION OF REDUNDANT ACTIVITIES

(71) Applicant: Lenovo Global Technology (United States) Inc., Morrisville, NC (US)

(72) Inventors: Gregory McNeil, Raleigh, NC (US); Matthew Dennis Kohut, Cary, NC (US); Mark Christopher Heidenfeldt, Apex, NC (US); Tarah Cook, Raleigh, NC (US)

(21) Appl. No.: 19/169,535

(22) Filed: Apr. 3, 2025

(51) Int. Cl. G06Q 10/10

(52) U.S. Cl. CPC G06Q 10/10

(57) ABSTRACT

One embodiment provides a method, the method including: monitoring, utilizing a redundant activity identification system, correspondence of users within an organization; identifying, utilizing an artificial intelligence model of the redundant activity identification system and based upon the monitoring, communications from the correspondence that are associated with a plurality of the users within the organization and that correspond to a similar issue; and notifying, using the redundant activity identification system, at least one of the plurality of users that another of the plurality of users is creating correspondence regarding the similar issue. Other aspects are claimed and described.

### BACKGROUND

Many organizations or entities may be large and have many different departments or groups that may work on different projects or issues. For example, an organization may have different groups that are assigned to work on different projects. Some of these projects may have similarities to each other, for example, an organization may have a group that works on designing widgets for a particular customer and another group that works on designing widgets for a different customer. These groups may be spread across different physical spaces.

### BRIEF SUMMARY

In summary, one aspect provides a method, the method including: monitoring, utilizing a redundant activity identification system, correspondence of users within an organization; identifying, utilizing an artificial intelligence model of the redundant activity identification system and based upon the monitoring, communications from the correspondence that are associated with a plurality of the users within the organization and that correspond to a similar issue; and notifying, using the redundant activity identification system, at least one of the plurality of users that another of the plurality of users is creating correspondence regarding the similar issue

Another aspect provides a system, the system including: a processor; a memory device that stores instructions that, when executed by the processor, causes the system to: monitor, utilizing a redundant activity identification system, correspondence of users within an organization; identify, utilizing an artificial intelligence model of the redundant activity identification system and based upon the monitoring, communications from the correspondence that are associated with a plurality of the users within the organization and that correspond to a similar issue; and notify, using the redundant activity identification system, at least one of the plurality of users that another of the plurality of users is creating correspondence regarding the similar issue.

A further aspect provides a product, the product including: a computer-readable storage device that stores executable code that, when executed by a processor, causes the product to: monitor, utilizing a redundant activity identification system, correspondence of users within an organization; identify, utilizing an artificial intelligence model of the redundant activity identification system and based upon the monitoring, communications from the correspondence that are associated with a plurality of the users within the organization and that correspond to a similar issue; and notify, using the redundant activity identification system, at least one of the plurality of users that another of the plurality of users is creating correspondence regarding the similar issue.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for notifying a user within an organization that another user within the organization appears to be working on the same or a similar issue within the organization.

### DETAILED DESCRIPTION

Groups of people who work on similar projects may end up working on the same issues for each project. For example, groups working on designing the same widget for different customers may end up having the same issues in the widget design. Additionally, even if an organization does not have groups of people working on the same or similar projects, some issues may be common across groups that are not working on the same or similar projects. For example, more than one group may need to fulfill orders to customers, even if the orders and/or customers are not the same across the multiple groups. Thus, different groups within an organization may have similar issues, even if the groups are not working on the same or similar projects.

When multiple groups of people face the same issue, each group may work to overcome the issue, meaning that multiple groups of people are trying to address the same issue. This results in multiple people unknowingly working on the same project, leading to a duplication of effort. Additionally, because the groups are working on the same issue disparately, different solutions may be found for the issue with different levels of success. Thus, this results in miscommunication, wasted resources, and misaligned deliverables, which affects productivity and timelines. Current solutions require manual communication and hierarchical intervention to identify similar project ideas. If the duplicative efforts are identified, it is after the affected groups have already spent time and money in working on a solution to the issue. Additionally, particularly in larger corporations, duplicative efforts may not even be identified at all, thereby resulting in completely wasted resources with more than one group working on the same issue.

Accordingly, the described system and method provides a technique for notifying a user within an organization that another user within the organization appears to be working on the same or a similar issue. The redundant activity identification system monitors correspondence of users within an organization. The correspondence may include emails, instant messages, text messages, telephone calls, video calls, meeting agendas or other meeting documentation, project reports, progress reports, and/or the like. The monitoring may be performed utilizing an artificial intelligence model.

From the monitored correspondence, the system may identify communications from the correspondence that are associated with multiple users within the organization and that corresponds to a similar issue. In other words, the system can identify that more than one user, who may be in disparate groups, are working on the same issue through the monitoring of the correspondence. To identify that communications may correspond to a similar issue, the system may identify that the communications include entities that are the same or similar, content that is the same or similar, topics that are the same or similar, users included in the communications that are the same or similar, and/or the like. The identification that communications correspond to a similar issue may be performed utilizing an artificial intelligence model. The artificial intelligence model may be a trained model, which may be trained on natural language, trained on all correspondence, trained on correspondence for the organization or groups within an organization, and/or the like. Thus, the artificial intelligence model may be unique to a particular organization or group.

Once a similar issue has been identified between multiple groups, the system may notify at least one of the users that another users is working on the same or similar issue. In other words, the system may notify at least one of the people who is working on an issue that another person in a different group might be working on the same or a similar issue. The notification could take different forms including, but not limited to, sending a message over a communication medium, providing a notification within a program or application that the user is utilizing, and/or the like. Thus, the system is able to connect the people who are working on the same or similar issue.

Therefore, a system provides a technical improvement over traditional methods for addressing users that may be unknowingly working on the same or a similar issue. The described system improves the technological field of computer communications. The described system provides a technique for identifying and addressing users working on the same or a similar issue. This makes for a more efficient use of resources within an organization. Additionally, the use of the artificial intelligence model to monitor correspondence and identify when more than one group is working on the same or a similar issue, is a more efficient use of computer resources because the artificial intelligence model can identify the duplication of efforts more quickly and efficiently than utilizing a user to monitor correspondence and identify duplicative efforts. Additionally, the described system connects the users together who are working on the same or similar project in a manner that quickly and effectively notifies the users by communicating to the users using a notification that can be provided in an application or program that the user is utilizing, which is quicker than other forms of providing notifications or communications to users.

The illustrated example embodiments will be best understood by reference to the figures. The following description is intended only by way of example, and simply illustrates certain example embodiments.

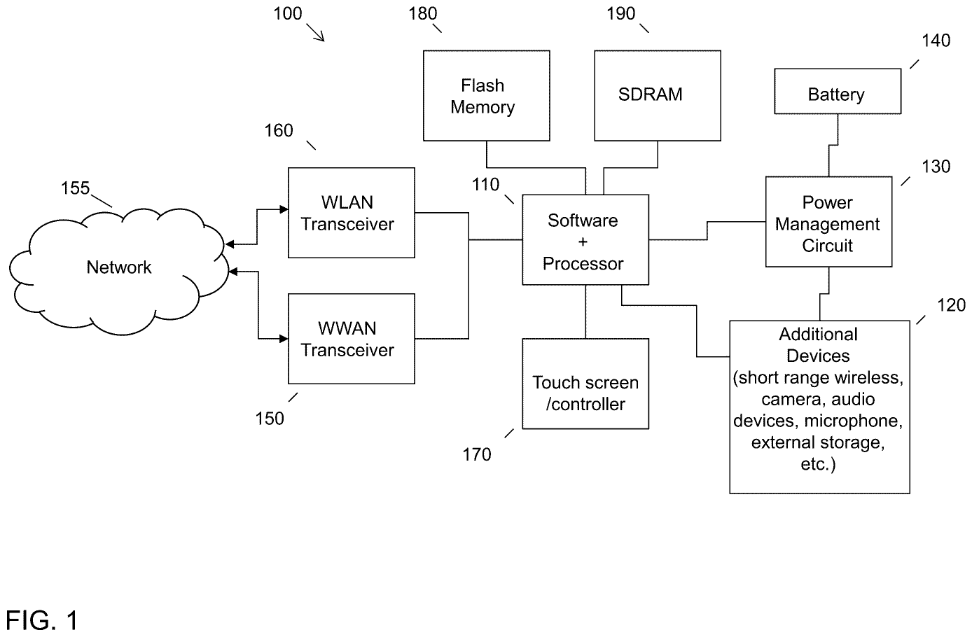

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

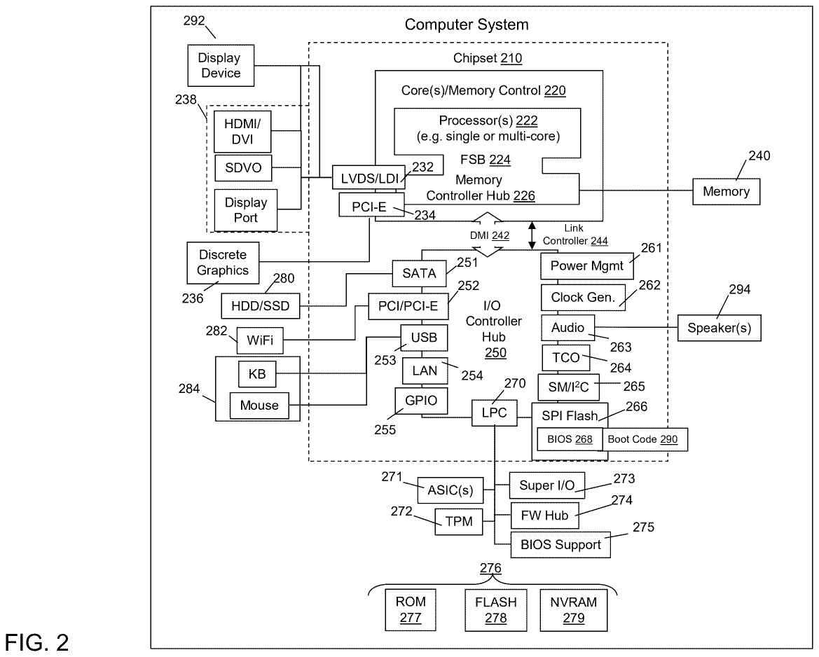

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices that users utilize to correspond with other users about issues, which may be devices that interface with the redundant activity identification system, and/or the like. For example, the circuitry outlined in FIG. 1 may be implemented in a tablet or smart phone embodiment, whereas the circuitry outlined in FIG. 2 may be implemented in a personal computer embodiment.

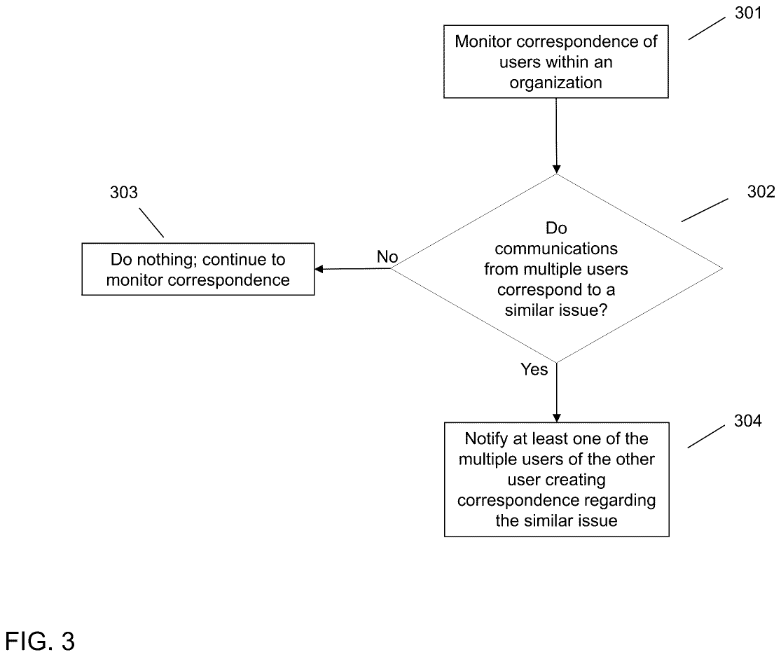

FIG. 3 illustrates an example method for notifying a user within an organization that another user within the organization appears to be working on the same or a similar issue. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to connect users that may be working on the same or a similar issue within an organization. Additionally, the redundant activity identification system includes modules and features that are unique to the described system.

The redundant activity identification system may be activated in order to identify when people within an organization may be working on the same or similar issue. The people may be located within different groups or departments of the organization, or the people may simply be people who do not work directly with each other and so do not know that someone else within the organization is working on the same issue. Accordingly, the redundant activity identification system is deployed to identify these potential duplicative efforts and to connect those people who are working on these efforts, so that time and resources can be saved and better solutions may be found for issues.

Activation of the redundant activity identification system may be a manual activation of the redundant activity identification system and/or an automatic activation of the redundant activity identification system. Manual activation of the system may include a user opening an application associated with the redundant activity identification system, the user accessing the computing system associated with the redundant activity identification system, and/or the user otherwise providing input to the redundant activity identification system. The automatic activation of the redundant activity identification system may be based upon the detection of a trigger event indicating that the system should be activated. Example trigger events include the user activating a correspondence medium or application, a user accessing an application that interfaces with the redundant activity identification system, activation of software or an application utilizing the redundant activity identification system, and/or the like. However, it should be noted, that the redundant activity identification system may be a background task that is activated by a person with authority to activate background tasks on user devices. Thus, the activation of the redundant activity identification system may not be an activation by a user of a particular device, but may rather be activated upon activation of the device.

The redundant activity identification system may be made of multiple systems or modules that communicate together to make up the redundant activity identification system or may be a single system. The redundant activity identification system may be a standalone system, may be accessible through other computing devices, and/or a combination thereof. For example, the redundant activity identification system may be a standalone system that can be accessed by a user and/or may be or provide an application that is accessible by a user on another computing device. The redundant activity identification system may be accessible using any type of computing device, for example, personal computer, laptop computer, smartphone, tablet, smartwatch, head-mounted display, smart television or other smart appliance, augmented reality device, virtual reality device, and/or the like.

Thus, the redundant activity identification system may be accessible locally using a computing device where the redundant activity identification system is installed and/or may be accessible remotely through another computing device. For example, the redundant activity identification system may be accessed by a user using a device that communicates with the redundant activity identification system to monitor correspondence of users within an organization, identify that more than one user is working on the same issue, notify users that more than one user is working on the same issue, and/or the like. However, the redundant activity identification system may be located and operate on a different information handling device to perform the described steps.

The redundant activity identification system may utilize one or more artificial intelligence models in monitoring correspondence of users, identifying that multiple users are working on a similar issue from the correspondence, notifying at least one user of the overlap in issues, and/or the like. Artificial intelligence models could be designed to monitor correspondence, identify communication from the correspondence that are associated with a plurality of users and that correspond to a similar issue, or any other steps within the described system. Artificial intelligence models may also be used for steps within a step. For example, a model could be utilized to identify a topic of communications in order to identify if the communications correspond to a similar issue, analyze correspondence in monitoring the correspondence, and/or the like.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the redundant activity identification system, or the artificial intelligence model may be a model that is created and trained from scratch. Since the redundant activity identification system is used in conjunction with monitoring correspondence and identifying that more than one user is working on the same issue, some models that may be utilized by the system are image analysis models, text analysis models, audio analysis models, analysis models, similarity identification models, language models, large language models, entity identification models, input analysis models, filtering models, classification models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The redundant activity identification system may include different components for carrying out different functions of the system, including different steps to be performed. These components may be hardware components or software components. Some hardware devices or components that may be utilized by the redundant activity identification system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the redundant activity identification system. For example, the redundant activity identification system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the redundant activity identification system, and/or the like.

One software component may include a data storage location or data repository that stores information related to correspondence, user profiles, entity profiles, artificial intelligence model training datasets, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by user, grouped by department or group, grouped by data source, and/or the like.

Another software component includes one or more training datasets that can be utilized by the artificial intelligence model in monitoring correspondence of users, identifying communications from the correspondence that indicate more than one user is working on the same issue, and/or the like. The training dataset may be unique for an organization, a group or department within the organization, a certain group of individuals or users, and/or the like. A unique training dataset will make the artificial intelligence model unique to the group that corresponds to the training dataset. For example, if the training dataset is unique to the organization, the artificial intelligence model will be unique to the organization. The training dataset can be utilized to train the artificial intelligence model to perform the desired function(s).

The training dataset may include historical correspondence between users within the organization, group or department, group of individuals, and/or the like. The training dataset may include an annotated dataset where the historical correspondence is marked with entities, topics, content, issues, projects, and/or the like. However, the training dataset does not have to be an annotated dataset. Some training techniques include, but are not limited to, unsupervised learning, semi-supervised learning, active learning, transfer learning, weak supervision, data augmentation, weakly supervised learning, and/or the like. Accordingly, the training dataset may include annotated data, unannotated data, and/or the like, or a combination thereof.

At 301, the redundant activity identification system may monitor correspondence of users within an organization. The correspondence may be any type of correspondence including, but not limited to, email communications, instant messaging communications, text message communications, video calls, telephone calls, meeting materials (e.g., agendas, summaries, presentation materials, notes, etc.), project correspondence, program or application correspondence (e.g., whiteboard, program or application-specific messaging, announcement board, etc.) which may be specific to a project, and/or the like. The monitoring of the correspondence may occur at a predetermine frequency, as new correspondence are identified, constantly, and/or the like. The frequency of the monitoring can be selected by a user, be a default frequency, can be set by an organization, and/or the like.

To monitor the correspondence, the system may utilize one or more monitoring techniques. The system may be a backend system that is active when certain applications and programs are active. For example, the system may be implemented within different correspondence programs or applications. Thus, when the correspondence programs or applications are active, the system will be active and will be able to access and, therefore, monitor any correspondence that is created through the program or application or that is received through the program or application. One technique for monitoring the correspondence is to use an artificial intelligence model. The artificial intelligence model may monitor the correspondence to determine if it might be pertinent to a particular issue or topic. Thus, when monitoring correspondence, the system may not simply identify that correspondence has been exchanged, but may also identify if the correspondence may be of interest to the system.

Identifying if correspondence is of interest to the system may include determining if there is information within the correspondence that indicates the correspondence might be related to an issue. To identify the information, the system may utilize one or more techniques, for example, entity identification, natural language processing, semantic analysis, syntactic analysis, object identification, parts-of-speech analysis, and/or the like. The information that is identified may include entities (e.g., people, organizations, locations, dates, names, project names, etc.), content identification, context identification, topic identification, recipients, subjects, users included in the correspondence, and/or any other information that may be useful to determine if more than one user is working on the same issue.

The information that is identified may be compared to a rule set, dataset, and/or the like, analyzed by an artificial intelligence model, and/or the like, to determine if the information corresponds to an issue. If the information does correspond to an issue, the system may mark, flag, pull, or otherwise identify that the corresponding correspondence or communication is related to an issue. These communications can then be analyzed at 302 to determine if multiple users might be working on the same issue.

At 302, the redundant activity identification system may determine if communications from multiple users correspond to the same or a similar issue. To determine if communications from multiple users correspond to the same or similar issue, the redundant activity identification system may identify, using an artificial intelligence model, communications from the correspondence that are associated with a plurality of users within the organization and that correspond to a similar issue. To make this identification, the system may compare the information that was identified from each of the correspondence at 301 with information that was identified from other of the correspondence at 301. In other words, once the information identifying that the communication is related to an issue is identified, the issue corresponding to the communications may be compared with issues identified from other communications.

To reduce processing, the system may filter the communications. For example, the system may only compare issues corresponding to communications against other communications for users who are not associated with the user of the first email. In other words, the system may identify users who are associated with each other, for example, in the same group, who work together, who communicate frequently, and/or the like. The system may then compare issues identified from communications of a user to communications of other users who are not associated with the user. Accordingly, the system may ignore communications that correspond to the same issue if the users associated with the communications are in the same group, appear to be working on the issue together, and/or the like. Thus, the system may only mark or flag communications that are related to the same issue and are associated with users that do not appear to know that the other user is working on the same issue.

Other techniques for filtering the communications are contemplated and possible, for example, only comparing issues of communications that are within a predetermined time period of each other, only comparing issues of communications when the issues have been worked on by a certain number of people, only comparing issues of communications with the issues have been worked on for a certain length of time, and/or the like.

In comparing the communications to identify that the communications correspond to a similar issue, the system may compare the information that was identified from the correspondence, which may be for all communications or only the subset of communications if the communications are filtered. The system may utilize any type of similarity identification technique, for example, cosine similarity, Euclidean distance, Jaccard similarity, word embeddings, and/or the like, or a combination thereof. Based upon the output of the similarity identification technique, the system can determine if the issues from compared communications are similar or the same. Issues from more than one communication may be identified as being similar or the same if the similarity is within a predetermined threshold. The predetermined threshold may be set by a user, set by an organization, set be a department, a default value, and/or the like.

Accordingly, for example, the system may identify that more than one user is working on the same or similar issue if at least one entity within the communications of different users has a similarity to each other within a predetermined similarity threshold. For example, if the identified entities are project names, program or application names, and/or the like, the system may determine that more than one user is working on the same or similar issue if the project names or program application names are the same or similar across the communications from the multiple users. As another example, the system may identify that more than one user is working on the same or similar issue if the content within the communications of different users has a similarity to each other within a predetermined similarity threshold. For example, if the content is a problem statement, content discussion, subject lines, and/or the like, the system may determine that more than one user is working on the same or similar issue if the problem statements, content discussion, subject lines, and/or the like, are the same or similar across the communications from multiple users.

As another example, the system may identify that more than one user is working on the same or similar issue if the topics within the communications of different users has a similarity to each other within a predetermined similarity threshold. For example, if the topics are potential solutions, identified problems, and/or the like, the system may determine that more than one user is working on the same or similar issue if the potential solutions, identified problems, and/or the like, are the same or similar across the communications from multiple users. As another example, the system may identify that more than one user is working on the same or similar issue if the recipients or other users included in the communications have a similarity to each other within a predetermined similarity threshold. For example, if the users copied on emails, included as recipients, discussed within an email, and/or the like, the system may determine that more than one user is working on the same or similar issue if the users copied on emails, included as recipients, discussed within an email, and/or the like, are the same or similar across the communications from multiple users.

If, at 302, the redundant activity identification system does not identify that communications from multiple users correspond to a similar issue, the system may do nothing and continue to monitor correspondence at 303. In other words, if the system is unable to identify communications from multiple users that correspond to a similar issue, the system may take no action regarding the communications and may continue to monitor correspondence.

On the other hand, if, at 302, the redundant activity identification system does identify that communications from multiple users correspond to a similar issue, the system may notify at least one of the multiple users of the other user creating correspondence regarding the similar issue at 304. In other words, if the system identifies that multiple users might be working on the same issue, the system may take steps to notify at least one of the users of the potential redundancy by another user. The system may then take steps to connect the users. To notify the users, the system may take one or more actions. The notification may include a communication to one or more of the users using a communication medium, for example, through an email application, an instant messaging application, text messaging application, and/or the like. The notification may also be through a pop-up or display of another type of graphical element.

The notification may also be through an application utilized by one or more of the users and that is associated with the similar issue. For example, the users may utilize a specific program or application to attempt to address the issue. The system could provide a notification through this program or application. The notification may differ based upon the capabilities and features of the program or application. For example, the notification may be displayed as a pop-up graphical element upon the user logging into the application, the notification may be placed in a bulletin board or other message board of the application or program, and/or the like. The notification could be performed utilizing an application programming interface (API) that allows the redundant activity identification program and other program (which could be the program used to work on the issue or another program).

The system may take additional steps to assist in connecting the users working on the similar issue. Some of these steps may be automated steps that would assist the users. For example, the system could automatically create a shared virtual space, such as a shared drive, folder, shared application, instant messaging groups, chat rooms, and/or the like, to be associated with the similar issue. The system can then grant the users who are all working on the similar issue access to the shared virtual space and then provide a notification to the users who have been granted access to the shared virtual space that the space has been created and the user has access to it.

As an overall, non-limiting example, an organization may have an engineering department attempting to build a subscription service. The organization may have a customer acquisition department also attempting to build a subscription service. These departments may not communicate to the point that members of the departments would recognize that both departments are working on the same issue. The described system would monitor the correspondence of the departments and may recognize that emails between members of each department discuss a subscription service. The system would identify that the communications from each department are related to the same issue of building a subscription service, and may then notify a member from each department that the other department is working on building a subscription service.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, the method comprising:
monitoring, by a redundant activity identification system, correspondence of a plurality of users within an organization, the correspondence comprising communications exchanged via one or more communication platforms;
extracting, from the correspondence, structured communication data associated with respective communications;
identifying, utilizing an artificial intelligence model of the redundant activity identification system and based on the structured communication data, a set of communications that are associated with a subset of the plurality of the users and correspond to a similar issue;
in response to identifying the similar issues, automatically creating by the redundant activity identification system, a shared virtual space associated with the similar issues, and assigning access permissions to the shared virtual space for the subset of the plurality of users based on association of the subset of the users with the set of communication; and
causing presentation, via at least one application utilized by at least one of the plurality of users, of a notification indicating available of the shared virtual apace for the similar issue.

2. The method of claim 1, wherein the identifying comprises performing entity identification within the communications and identifying at least one entity within communications of different of the plurality of users having a similarity to each other within a predetermined threshold.

3. The method of claim 1, wherein the identifying comprises identifying content within the communications and identifying that the content within the communications of different of the plurality of users have a similarity to each other within a predetermined threshold.

4. The method of claim 1, wherein the identifying comprises identifying topics within the communications and identifying that the topic within the communications of different of the plurality of users are the same.

5. The method of claim 1, wherein the identifying comprises identifying users included within the communications and identifying that users included within the communications of different of the plurality of users overlap.

6. The method of claim 1, wherein the artificial intelligence model is a trained artificial intelligence model that is trained on the correspondence of the organization to make the trained artificial intelligence model unique to the organization.

7. The method of claim 1, wherein the monitoring is performed by the artificial intelligence model.

8. The method of claim 1, wherein the notifying of the at least one of the plurality of users comprises transmitting a notification using a communication medium.

9. The method of claim 1, wherein the notifying of the at least one of the plurality of users comprises providing a notification within an application utilized by the at least one of the plurality of users and associated with the similar issue.

10. (canceled)

11. A system, the system comprising:
a processor;
a memory device that stores instructions that, when executed by the processor, causes the system to:
monitor, by redundant activity identification system, correspondence of a plurality of users within an organization, the correspondence comprising communications exchanged via one or more communication platforms;
extract, from the correspondence, structured communication data associated with respective communications;
identify, utilizing an artificial intelligence model of the redundant activity identification system and based on the structured communication data, a set of communications that are associated with a subset of the plurality of the users and correspond to a similar issue;
in response to identifying the similar issues, automatically creating by the redundant activity identification system, a shared virtual space associated with the similar issues, and assigning access permissions to the shared virtual space for the subset of the plurality of users based on association of the subset of the users with the set of communication; and
cause presentation, via at least one application utilized by at least one of the plurality of users, of a notification indicating available of the shared virtual apace for the similar issue.

12. The system of claim 11, wherein the identifying comprises performing entity identification within the communications and identifying at least one entity within communications of different of the plurality of users having a similarity to each other within a predetermined threshold.

13. The system of claim 11, wherein the identifying comprises identifying content within the communications and identifying that the content within the communications of different of the plurality of users have a similarity to each other within a predetermined threshold.

14. The system of claim 11, wherein the identifying comprises identifying topics within the communications and identifying that the topic within the communications of different of the plurality of users are the same.

15. The system of claim 11, wherein the identifying comprises identifying users included within the communications and identifying that users included within the communications of different of the plurality of users overlap.

16. The system of claim 11, wherein the artificial intelligence model is a trained artificial intelligence model that is trained on the correspondence of the organization to make the trained artificial intelligence model unique to the organization.

17. The system of claim 11, wherein the monitoring is performed by the artificial intelligence model.

18. The system of claim 11, wherein the notifying of the at least one of the plurality of users comprises transmitting a notification using a communication medium.

19. The system of claim 11, wherein the notifying of the at least one of the plurality of users comprises providing a notification within an application utilized by the at least one of the plurality of users and associated with the similar issue.

20. A product, the product comprising:
a computer-readable storage device that stores executable code that, when executed by a processor, causes the product to:
monitor, by a redundant activity identification system, correspondence of a plurality of users within an organization, the correspondence comprising communications exchanged via one or more communication platforms;
extract, from the correspondence, structured communication data associated with respective communications;
identify, utilizing an artificial intelligence model of the redundant activity identification system and based on the structured communication data, a set of communications that are associated with a subset of the plurality of the users and correspond to a similar issue;
in response to identifying the similar issues, automatically creating by the redundant activity identification system, a shared virtual space associated with the similar issues, and assigning access permissions to the shared virtual space for the subset of the plurality of users based on association of the subset of the users with the set of communication; and
cause presentation, via at least one application utilized by at least one of the plurality of users, of a notification indicating available of the shared virtual apace for the similar issue.
